(19) United States
(12) Patent Application Publication
(10) Pub. No.: US 2019/0323478 A1
(43) Pub. Date: Oct. 24, 2019

(54) HYDROPOWER GENERATOR

(71) Applicant: SEOJUN CO., LTD., Gangneung-si, Gangwon-do (KR)

(72) Inventor: Min Si JUNG, Gangneung-si (KR)

(73) Assignee: SEOJUN CO., LTD., Gangneung-si, Gangwon-do (KR)

(21) Appl. No.: 16/314,605

(22) PCT Filed: Jul. 28, 2017
(86) PCT No.: PCT/KR2017/008139

§ 371 Date: Dec. 31, 2018

(30) Foreign Application Priority Data
Jul. 28, 2016 (KR) 10-2016-0096165
Dec. 29, 2016 (KR) 10-2016-0182333

(51) Int. Cl. F03B 17/06; H02K 7/18; F03B 13/10

(52) U.S. Cl. CPC F03B 17/065; F05B 2240/90; F03B 13/10; H02K 7/1823

(57) ABSTRACT

The present invention relates to a hydropower generator for generating electricity by rotating in a fluid flow direction, the hydropower generator comprising: a central structure installed so as to be able to stand erect in water; a rotator installed on an outer circumferential surface of the central structure, and having at least one resistive plate coupled to the outer circumferential surface thereof; a rotating ring provided between the central structure and the rotator to cause the rotator to rotate around the central structure; a speed changing unit which integrally rotates by means of one side thereof coupled to the rotator; and a generator having a motor shaft coupled to the other side of the speed changing unit, and generating energy by rotation of the motor shaft, wherein the resistive plate is located in the water and generates resistive force according to the flow of water while the rotator rotates, such that energy is generated from the generator. Therefore, the present invention can provide a hydropower generator which is efficient in management, control, and extension of lifespan, and is cost-effective in the installation thereof.

### TECHNICAL FIELD

The present invention relates to a hydropower generator, more particularly, to a hydropower generator enabling electricity generation by a flow of fluid, wherein a rotator rotates in the same direction by a resistance force generated in a resistance plate regardless of a flow direction of the fluid in the hydropower generator.

### BACKGROUND ART

Generation of electricity generally uses hydroelectric power, tidal power, thermal power, nuclear power, wind power, solar power, etc. and, in the case of thermal power generation, nuclear power plants need not only enormous consumption of energy and high technology for operation, human resources, expensive high-tech equipment, significant installation and maintenance costs, but also involve problems of adverse effects wherein massive amounts of deadly environmental pollutants are generated.

Therefore, in consideration of domestic conditions wherein the country is a peninsula and is rich in mountainous regions with variable wind, Korea has great interest in development of environmentally friendly, low-carbon and renewable green energy using wind power or tidal power.

Meanwhile, the conventional wind power devices mostly installed and used in the art have adopted propeller type rotation and are characterized in that a power transmitter is mounted on the top end of a vertically-installed support shaft, and a single rotary blade unit is installed on one side of the power transmitter wherein this single rotary blade unit consists of three or four blades radially arranged at equal angle within a predetermined diameter and has a structure of being mounted perpendicularly toward the direction of blowing wind. The conventional wind power generator having such a structure as described above is not reasonable since only a single rotary blade unit is vertically installed on the top end of the support shaft such as a fan blade, and thus, a small amount of power generation is expected only by rotation of the single rotary blade unit. In order to increase power generation, the afore-described structure should be installed in large numbers in a large area, hence causing limitation in power generation to be achieved, compared to enormous installation site and investment costs.

Further, conventionally, a fixed position was determined only by a force of pushing the resistance plate along water flow, which caused a problem that it is difficult to fully utilize the pushing force if the resistance plate is heavy.

Further, since a rotational direction may vary according to a change in the direction of water flow, it was difficult to actually operate a power generator.

### DISCLOSURE

### Technical Problem

The present invention was conceived to solve the above problems, and an object of the present invention is to provide a hydropower generator wherein a resistance plate is disposed in water and generates a resistance force along a flow of the water while rotating a rotator, and a generator is installed on the surface of water, thereby enabling efficient management, control and lifespan extension of facilities while achieving reduction in installation costs.

Further, there is provided specific arrangement and structure of the resistance plate that can rotate in the same direction even though the direction of water flow is changed.

### Technical Solution

According to characteristics of the present invention to accomplish the above objects, there is provided a hydropower generator for generating electricity while rotating in a flow direction of fluid, which includes: a central structure installed to stand upright in water; a rotator installed on an outer circumference of the central structure and having at least one resistance plate coupled to the outer circumference; a rotational ring provided between the central structure and the rotator to allow the rotator to rotate around the central structure; a speed changing unit (‘transmission’) which is coupled to the rotator at one side of the transmission and integrally rotates along with the rotator; and a generator having a motor shaft coupled to the other side of the transmission to generate energy by rotation of the motor shaft, wherein the resistance plate is disposed in the water and generates a resistance force along water flow while rotating the rotator, simultaneously, thereby generating energy by the generator, and wherein the resistance plate is configured to be arranged to generate a rotating force such that the rotator can rotate in the same direction regardless of the direction of flow.

In order to attain the above operations, the resistance plate may include: a plurality of rotary supports formed in radial directions with respect to the rotator; and a resistance plate rotatably coupled to one side of the rotary support, which is opposed to the rotator, by a hinge, wherein the rotary support further includes a support part to which the resistance plate is rotatably coupled and by which the resistance plate is supported, wherein the resistance plate receives a force of the fluid and generates a rotating force in order to rotate the rotator wherein the rotating force reaches maximum at an angle having 90 degrees difference from a direction of flow (‘the angle for maximum rotating force’) while reaching minimum at an angle having 180 degrees difference from the above angle for maximum rotating force (‘the angle for minimum rotating force’), and wherein the resistance plate at the angle for maximum rotating force is arranged in a direction perpendicular to the direction of the flow rate, while the resistance plate at the angle for minimum rotating force is arranged in a direction parallel to the direction of the flow.

In the other words, a portion of the rotary support stops rotation of the resistance plate to generate a resistance force, and the resistance plate generates the resistance force while rotating at one side of the rotary support toward the center of the rotator, wherein the resistance force reaches maximum when the resistance plate is arranged to be superimposed on the rotary support, thereby maximizing the rotating force.

At a position at which the rotating force is generated, the resistance plate is arranged to be superimposed on the rotary support so that the rotary support may become parallel to the resistance plate. On the other hand, at a position at which the rotating force is not generated, the resistance plate is arranged parallel to the direction of flow so as to rotate the rotator due to a deviation in rotating forces generated in the resistance plate.

In another aspect of the present invention, the resistance plate is rotatably coupled to one side of the rotary support by a hinge to thus rotates depending upon the direction of flow, wherein the rotating resistance plate at an angle for maximum rotating force is arranged to be superimposed on the rotary support and thus causes the rotary support to be parallel to the resistance plate, while the rotating resistance plate at angle for minimum rotating force is arranged to be widened by 90 degrees from the rotary support and thus causes the rotary support to be perpendicular to the resistance plate.

In another aspect of the present invention, when viewing the rotator in the direction of flow, if the resistance plate and the rotary support are arranged to provide the maximum rotating force at the left side, the rotator may rotate in the clockwise direction, whereas, if the resistance plate and the rotary support are arranged to provide the maximum rotating force at the right side, the rotator may rotate in the counterclockwise direction.

That is to say, when viewing the rotator in the direction of flow, if the resistance plate and the rotary support are arranged such that rotation of the resistance plate is stopped by the rotary support at the right side relative to the rotator to thus generate the resistance force (see FIGS. 5a and 5b), the rotator may rotate in the counterclockwise direction. On the contrary, if the resistance plate and the rotary support are arranged such that rotation of the resistance plate is stopped by the rotary support at the left side relative to the rotator to thus generate the resistance force, the rotator may rotate in the clockwise direction.

Further, the present invention may further include a base member for supporting the rotator and the central structure, wherein the rotator has a hollow cylindrical form and receives a portion of the central structure therein, wherein a cover part having a thru-hole through which the central structure passes is formed on top of the rotator, and wherein the central structure has a stepped part projecting in the radial direction from the outer circumference of the central structure such that the central structure is spaced apart from the bottom of the cover part of the rotator.

In this case, the rotational ring provided between the rotator and the central structure may include a plurality of internal rolling rings with a multilayer structure present between an inner circumference of the rotator and an outer circumference of the central structure, wherein the internal rolling rings are provided to support the rotator, thereby enabling the rotator to rotate about a center axis of the central structure.

In addition, the rotational ring may further include: an upper rolling ring provided between the cover part of the rotator and the stepped part of the central structure to support an upper portion of the rotator; a lower rolling ring provided between the base member and the bottom of the rotator to support a lower portion of the rotator, wherein both of the upper rolling ring and the lower rolling ring may be provided together or either one thereof may be selectively provided.

Further, the internal rolling ring may include: an inner ring having a protrusion projecting from an inner circumference of the inner ring; a rolling body provided on an outer circumference of the inner ring; and an outer ring that has an outer circumference in close contact with the inner circumference of the rotator and is rotated around the central structure while surrounding the rolling body, wherein these respective components are provided in one or more numbers and are spaced apart in a length direction of the central structure.

Further, a portion of the rotary support may stop rotation of the resistance plate to thus generate a resistance force (see FIGS. 5a and 5b), wherein a face contacting with the resistance plate to stop the resistance plate has a recess 240 formed in a concave or planar shape in order to increase the resistance force, while the opposite face may include a convex part 241 formed to decrease the resistance force against fluid.

The recess 240 or the convex part 241 may be formed in a straight or curved line (see FIG. 5e or 5f).

Further, the hinge rotatably coupled to the resistance plate may have a configuration wherein a single hinge is disposed in the center of one end of the resistance plate (see FIG. 5c) or is mounted on a bracket 182 extending up and down from the end of the rotary support to support top and bottom faces of the resistance plate (see FIG. 5a).

Moreover, the resistance plate may be in a curved form having a wider width with increasing distance from the hinge, so as to prevent foreign substances from sticking to the resistance plate.

Further, the rotary support and the resistance plate may be formed with at least one multilayer structure, wherein the rotary support and the resistance plate are divided and mounted at equal angle of 360 degrees on each layer, and the rotary support may be horizontally arranged or inclined.

Herein, FIG. 1 illustrates a structure consisting of three layers, wherein each layer is provided with two rotary supports and two resistance plates, respectively. However, the number of the layers can of course be altered.

In another aspect, the present invention may further include a base member at the bottom end of the central structure to support the central structure to stand upright.

Further, the central structure may include a guide groove inserted in an up-and-down direction to have an outer circumference and a fixing groove into which one side of the guide groove is inserted. Further, the internal rolling ring may move up and down by inserting the protrusion into the guide groove, while being fixed by inserting the protrusion into the fixing groove.

Also, the guide groove is formed to have a width between both inner faces, which is increased as the guide groove is more deeply inserted.

Moreover, in order to secure the internal rolling ring coupled in the center of the rotator when the protrusion is inserted into the fixing groove, a fixing rod inserted into the guide groove may be further included.

Further, the lower rolling ring may include: a first support ring, a lower side of which is supported on the bottom; a rolling body provided on top of the first support ring; and a second support ring which supports the bottom of the rotator while surrounding the rolling body, and rotates around the central structure.

Alternatively, the upper rolling ring may include: a first support ring which is supported at the stepped part of the central structure; a rolling body provided on top of the first support ring; and a second support ring which supports the bottom of the cover part while surrounding the rolling body, and rotates around the central structure.

Further, the rotator may be provided with a gear member on an upper portion of the outer circumference of the rotator, and the transmission may include: a power connection gear coupled to the above gear member in the rotator; a gear shift coupled to a motor shaft of the power generator; and a power transmission shaft which connects the power connection gear and the gear shift to transmit the rotating force, wherein a rotational speed of the rotator can be varied depending upon the number of teeth of both the power connection gear and the gear shift.

Further, the rotator may include: a plurality of rotary supports provided in a direction perpendicular to the central structure; and at least one resistance plate provided in the rotary support, one side of which is rotatably coupled to the rotary support by a hinge, wherein the rotary support includes a support part, at one end of which the resistance plate is rotatably coupled and by which the resistance plate is supported, wherein the support part may consist of at least one support part.

### Advantageous Effects

In accordance with the present invention as described later discussed, there is provided a hydropower generator that enables efficient management, control and lifespan extension of facilities, and achieves installation cost reduction.

According to the present invention, there is provided a hydropower generator with advantages wherein the resistance plate may be rotatably coupled to the support part of the rotary support in diverse modes, and adjusting the number of the rotary supports may further increase resistance caused by fluid, facilitate rotation of the rotator and further improve electric power generation.

### DESCRIPTION OF DRAWINGS

FIG. 1 is a perspective view illustrating a hydropower generator according to a preferred embodiment of the present invention.

FIG. 2 is an exploded perspective view illustrating a hydropower generator according to a preferred embodiment of the present invention.

FIG. 3 is a perspective view illustrating a hydropower generator according to a preferred embodiment of the present invention.

FIG. 4 is a cross-sectional view illustrating a hydropower generator according to a preferred embodiment of the present invention.

FIG. 5 is a perspective view illustrating a coupling relationship between a rotary support and a resistance plate in the hydropower generator according to a preferred embodiment of the present invention.

FIG. 6 illustrates behavior of the rotary support and the resistance plate according to a direction of fluid in the present invention.

FIG. 7 illustrates behavior of a rotator according to another embodiment in the rotary support of the present invention.

FIG. 8 is a front view illustrating a resistance plate according to another embodiment of the present invention.

FIG. 9 illustrates a shape as viewed in direction “A” in FIG. 8.

FIG. 10 is a perspective view illustrating the resistance plate shown in FIG. 8.

### BEST MODE

In order to accomplish the purposes of the present invention, preferred embodiments of the present invention provide a hydropower generator to generate electricity while rotating in a flow direction of fluid, which includes: a central structure installed to stand upright in water; a rotator installed on an outer circumference of the central structure and having at least one resistance plate coupled to the outer circumference; a rotational ring provided between the central structure and the rotator to allow the rotator to rotate around the central structure; a transmission which is coupled to the rotator at one side of the transmission and integrally rotates along with the rotator; and a generator having a motor shaft coupled to the other side of the transmission to generate energy by rotation of the motor shaft,

wherein the resistance plate is disposed in the water and generates a resistance force along water flow while rotating the rotator, simultaneously, thereby generating energy from the generator, and wherein the resistance plate is configured to be arranged to generate a rotating force such that the rotator can rotate in the same direction regardless of the direction of flow.

### Preferred Embodiments of Invention

With reference to embodiments that are described later in detail and in conjunction with the accompanying drawings, methods of accomplishing the advantages and features of the present invention will be apparent. However, the invention is not limited to the embodiments set forth herein and may be embodied in many different forms. The present embodiments are provided only to complete the disclosure of the present invention and inform one having ordinary skill in the art of the concept and scope of the invention, while the present invention will only be defined by the appended claims. Like reference numerals refer to like elements throughout the specification.

Hereinafter, the present invention will be described in detail by means of the following embodiments of the present invention with reference to the accompanying drawings illustrating the hydropower generator.

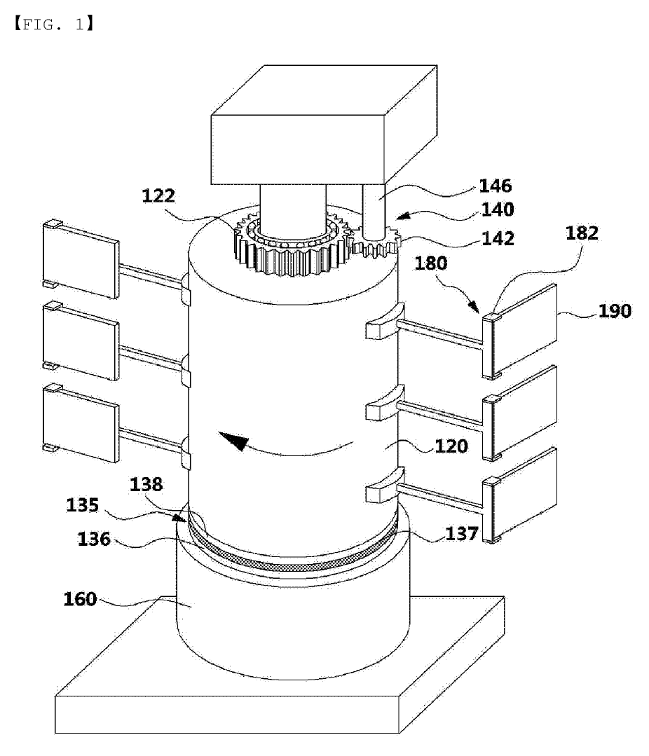

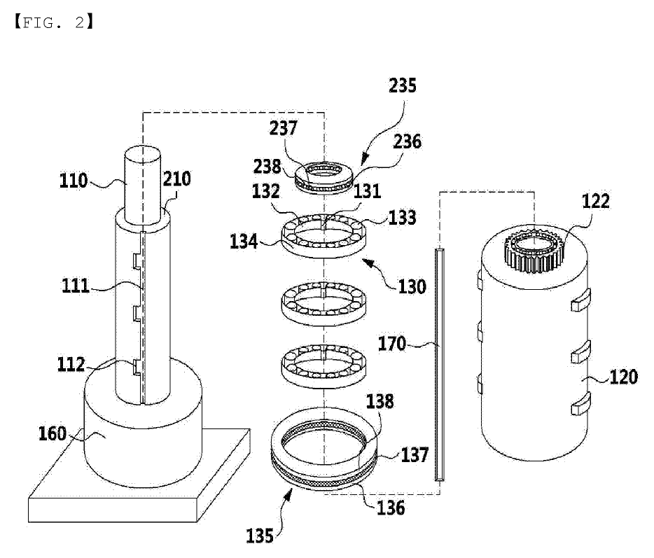

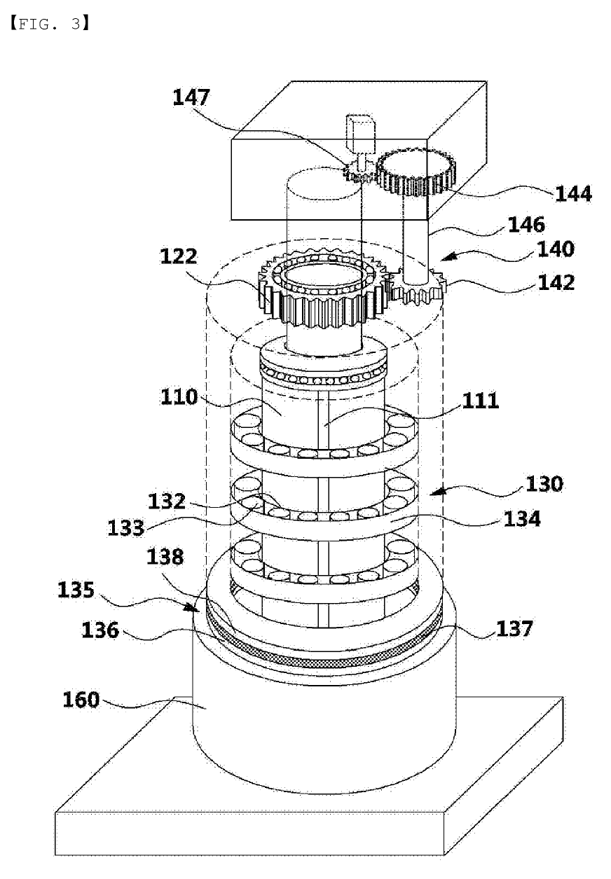

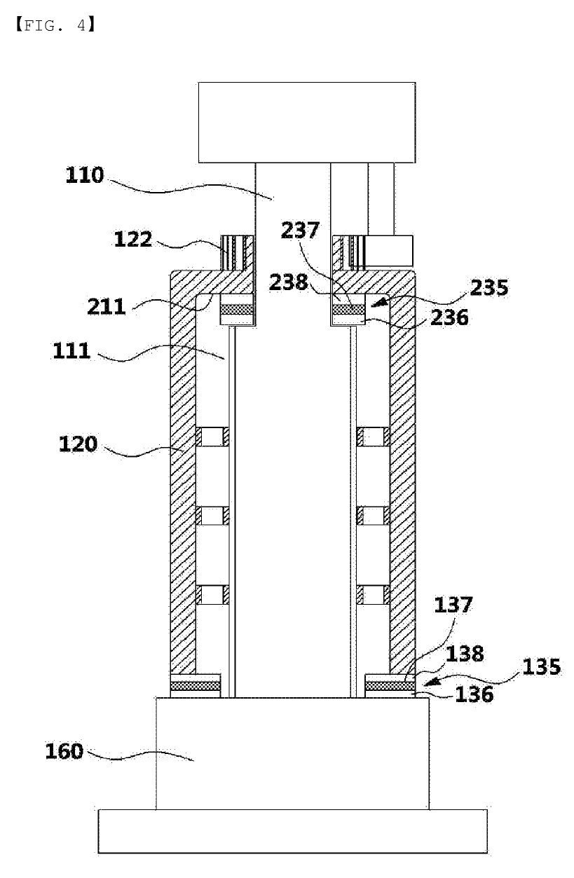

FIG. 1 is a perspective view illustrating a hydropower generator according to a preferred embodiment of the present invention, FIG. 2 is an exploded perspective view illustrating a hydropower generator according to a preferred embodiment of the present invention, FIG. 3 is a perspective view illustrating a hydropower generator according to a preferred embodiment of the present invention, and FIG. 4 is a cross-sectional view illustrating a hydropower generator according to a preferred embodiment of the present invention.

First, the hydropower generator according to the present invention generates electricity by rotation in a flow direction of fluid.

Referring to FIGS. 1 to 4, the hydropower generator of the present invention includes a central structure 110, a rotator 120 and a rotational ring, a transmission 140 and a generator 150.

The central structure 110 is installed to stand upright in water.

The central structure 110 may include a guide groove 111 inserted in an up-and-down direction to have an outer circumference and a fixing groove 112 into which one side of the guide groove 111 is inserted.

Herein, a width between both inner faces of the guide groove 111 may increase with increasing insertion depth of the guide groove.

Further, the hydropower generator of the present invention may further include a fixing rod 170.

The fixing rod 170 is inserted into the guide groove 111 such that an upper ring coupled to the center of the rotator 120 may be secured by inserting a protrusion 131 into the fixing groove 112.

Herein, a planar cross-sectional area of the fixing rod 170 is formed to correspond to a planar cross-sectional area of the guide groove 111. Further, when the fixing rod 170 is coupled to the guide groove 111, the fixing rod can only move up and down since the width between both inner faces of the guide groove 111 is increased as the guide groove 111 is inserted more deeply.

Further, the fixing rod 170 serves to prevent an internal rolling ring 130 coupled to the fixing rod 170 from not rotating while moving toward the guide groove 111.

Further, the hydropower generator of the present invention may further include a base member 160.

The base member 160 is provided at a lower end of the central structure 110 and supports the central structure 110 to stand upright.

The rotator 120 is installed on an outer circumference of the central structure 110, and at least one resistance plate 190 is coupled to an outer circumference of the rotator.

The rotator 120 includes a gear member 122 on an upper portion of the outer circumference of the rotator.

The rotational ring is provided between the central structure 110 and the rotator 120 to allow the rotator 120 to rotate around the central structure 110.

Herein, the rotational ring may include an internal rolling ring 130, a lower rolling ring 135 and an upper rolling ring 235.

The internal rolling ring 130 may be provided between an outer circumference of the central structure 110 and an inner circumference of the rotator 120 to support the rotator 120.

In this regard, the internal rolling ring 130 may move up and down by the protrusion 131 formed in the guide groove 111 and may be inserted into and secured in the fixing groove 112.

Further, the internal rolling ring 130 may include an inner ring 132, a rolling body 133 and an outer ring 134.

The inner ring 132 may have the protrusion 131 projecting from an inner circumference thereof.

The rolling body 133 is mounted on the outer circumference of the inner ring 132.

The outer ring 134 surrounds the rolling body 133, and rotates around the central structure 110 while an outer circumference of the outer ring 133 is in close contact with the inner circumference of the rotator 120.

Herein, the inner rolling ring 130 may be provided in one or more numbers, which is(are) preferably arranged and spaced apart in a length direction of the central structure 110.

That is, the inner ring 132 is inserted into and secured in the fixing groove by the fixing rod 170, while the outer ring 134 is in close contact with the rotator 120 and then rotated.

Moreover, the inner rolling ring 130 has a configuration of minimizing friction between the central structure 110 and a rotating shaft, and may also be formed in other different structures.

A base member 160 for supporting the rotator 120 and the central structure 110 may be further included. Further, the rotator 120 may have a hollow cylindrical shape wherein a portion of the central structure 110 is accepted in the rotator 120.

In addition, a cover part 211 having a thru-hole through which the central structure 110 passes is formed on top of the rotator 120, while the central structure 110 may have a stepped part 210 projecting in the radial direction from the outer circumference of the central structure 110 such that the central structure 110 is spaced apart from the bottom of the cover part 211 of the rotator 120.

Briefly, the rotator 120 has a hollow cylindrical form having a thru-hole wherein a diameter of a lower portion of the thru-hole is larger than a diameter of an upper portion thereof, while a cover part 211 is formed perpendicular to a center line on a position in the rotator, at which the diameter of the rotator is varied from the larger one to the smaller one.

On the other hand, the central structure 110 has a non-hollow cylindrical form, wherein a diameter of a lower portion of the central structure is larger than a diameter of an upper portion thereof, and has a stepped part 210 formed perpendicular to the center line on a position in the central structure, at which the diameter of the central structure is varied from the larger one to the smaller one.

The rotational ring provided between the rotator 120 and the central structure 110 may include a plurality of internal rolling rings 130 in a multilayer structure, which are disposed between the inner circumference of the rotator 120 and the outer circumference of the central structure 110.

Therefore, the rotator 120 may be supported by the internal rolling rings 130 so that the rotator 120 may rotate with reference to a center axis of the central structure 110.

Further, the rotational ring may include an upper rolling ring 235 provided between the cover part 211 of the rotator 120 and the stepped part 210 of the central structure 110 in order to support the upper portion of the rotator 120, and a lower rolling ring 135 provided between the base member 160 and the bottom of the rotator 120 in order to support the lower portion of the rotator 120.

In this case, the upper rolling ring 235 and the lower rolling ring 135 may be provided together or either one thereof may be selectively provided.

Meanwhile, the upper rolling ring 235 may include a first support ring 236, a rolling body 237 and a second support ring 238.

The first support ring 236 is supported on the stepped part 210 of the central structure 110.

The rolling body 237 is provided on top of the first support ring 236.

The second support ring 238 surrounds the rolling body 237, supports the cover part 211 of the rotator 120 and rotates around the central structure 110.

That is, the second support ring 238 has a rolling motion by the rolling body 237 when pressed by a load of the rotator 120, thereby minimizing friction with the first support ring 236.

Accordingly, the rotator 120 is supported on the lower rolling ring 235 and is rotated while minimizing friction due to the load.

The lower rolling ring 135 is provided between the base member 160 of the central structure 110 and the bottom of the rotator 120 in order to support the rotator 120.

The lower rolling ring 135 is coupled to the lower portion of the central structure 110 in order to support the bottom of the rotator 120.

In this case, the lower rolling ring 135 may include a first support ring 136, a rolling body 137 and a second support ring 138.

The first support ring 136 is supported on the base member 160

The rolling body 137 is provided on the top of the first support ring 136.

The second support ring 138 surrounds the rolling body 137, supports the bottom of the rotator 120, and rotates around the central structure 110.

That is, the second support ring 138 has a rolling motion by the rolling body 137 when pressed by a load of the rotator 120, thereby minimizing friction with the first support ring 136.

Accordingly, the rotator 120 is supported on the lower rolling ring 135 and is rotated while minimizing friction due to the load.

Herein, since the upper rolling ring 235 and the lower rolling ring 135 have substantially the same configuration, the same terms are used for the first support ring, the second support ring and the rotator. In this regard, the transmission 140 is coupled to the rotator 120 at one side thereof and integrally rotates with the rotator.

Herein, the transmission 140 may include a power connection gear 142, a gear shift 144 and a power transmission shaft 146.

The power connection gear 142 is coupled to a gear member 122 formed on the outer circumference of the rotator 120.

The gear shift 144 is coupled to a motor shaft 147 of a generator 150.

The power transmission shaft 146 connects the power connection gear 142 and the gear shift 144 to transmit a rotating force thereto.

That is, depending upon the number of teeth of the power connection gear 142 and the gear shift 144, a rotational speed of the rotator 120 can be varied.

In addition, the hydropower generator according to the present invention may further include a rotary support 180 and a resistance plate 190.

The rotary support 180 is provided in a direction perpendicular to the central structure 110 of the rotator 120.

In this regard, the rotary support 180 is preferably provided in plural.

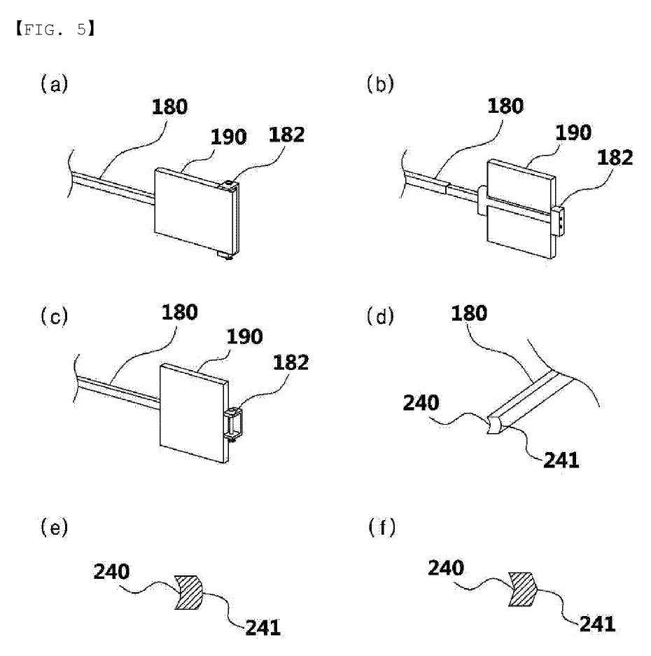

At least one resistance plate 190 is provided on the rotary support 180, wherein one side of the resistance plate 190 is rotatably coupled to the rotary support 180 by a hinge (see FIG. 5a).

Herein, the rotary support 180 may include a support part 182.

The resistance plate 190 is rotatably coupled to and supported by an end of the support part 182.

In this case, the support part 182 is preferably formed of at least one support part.

That is, the resistance plate 190 is disposed in water to generate a resistance force along water flow and, at the same time, the rotator 120 rotates to generate electric energy from the generator 150.

FIG. 5 is a perspective view illustrating a coupling relationship between the rotary support and the resistance plate in the hydropower generator according to a preferred embodiment of the present invention.

Referring to FIG. 5, the resistance plate 190 according to another embodiment of the present invention will be described below.

First, the resistance plate 190 will be described with reference to FIG. 5b.

The rotary support 180 is provided in a direction perpendicular to the rotator 120.

Herein, the rotary support 180 is preferably provided in plural in a length direction of the rotator 120.

Further, the rotary support 180 includes a support part 182.

The resistance plate 190 described below is rotatably coupled to and supported by an end of support part 182.

In this case, a pair of support parts 182 is provided and spaced apart by a predetermined distance. That is, the resistance plate 190 is rotatably coupled between the pair of support parts 182.

Next, the resistance plate 190 will be described with reference to FIG. 5c.

The rotary support 180 is provided in a direction perpendicular to the rotator 120.

The rotary support 180 is preferably provided in plural, in particular, a plurality of rotary supports 180 may be provided in a length direction of the rotary supports 180. Further, the rotary supports 180 are laminated one above another (that is, up and down), optionally, a plurality of rotary supports 180 may be provided.

The rotary support 180 may include a support part 182.

The resistance plate 190 is rotatably coupled to and supported by one end of the support part 182.

In this case, the support part 182 is preferably formed of at least one support part.

Further, the support part 182 may include an upper support part and a lower support part.

The upper support part and the lower support part are formed on top and bottom, respectively, to oppose each other.

Further, on the bottom of the upper support part and on the top of the lower support part, that is, on both surfaces of the upper and lower support parts facing each other, rotational balls are provided.

Further, on both surfaces of the upper and lower support parts facing each other, a stopper is projected and formed.

Herein, the stopper is formed on both of the upper support part and the lower support part, wherein the stopper is inclined at an angle such that one side of the resistance plate 190 described below is more inserted as long as a constant angle (θ) in the rotational direction rather than the other side thereof.

Herein, the constant angle (θ) preferably ranges from 1 to 10 degrees, without being limited thereto.

Accordingly, when the resistance plate 190 is supported on the stopper, it is supported at an angle in a direction of centrifugal force during rotation of the rotator 120 and does not further rotate, thereby not being folded or bent to the outside by the centrifugal force.

That is, the resistance plate 190 is formed on the upper support part and the lower support part wherein one side of the resistance plate 180 is inclined to be more inserted by a constant angle (θ) in the rotational direction rather than the other side thereof so that the resistance plate 190 can be stably supported on the stopper, thereby preventing separation of the resistance plate 190 from the stopper caused by the direction of flow or the centrifugal force.

At least one resistance plate 190 is provided on the rotary support 180 and may be provided in a length direction or a vertical direction of the rotary support 180.

Further, the resistance plate 190 is formed in a hollow shape on the other side opposite to a site of the rotary support at which the fixing hole is formed, and has an insertion part with an open side.

The resistance plate 190 may further include an auxiliary resistance plate 192.

The auxiliary resistance plate 192 is inserted into the resistance plate 190 through the insertion part and has a variable length projecting from one side of the resistance plate 190.

Accordingly, with respect to the hydropower generator of the present invention, the rotary support 180 may rotate by resistance of the resistance plate 190 to a fluid, and the resistance plate 190 may maintain a position owing to rotation of the rotator 120 without being affected by a flow direction of the fluid and generate resistance to thus induce generation of electricity by movement of the fluid.

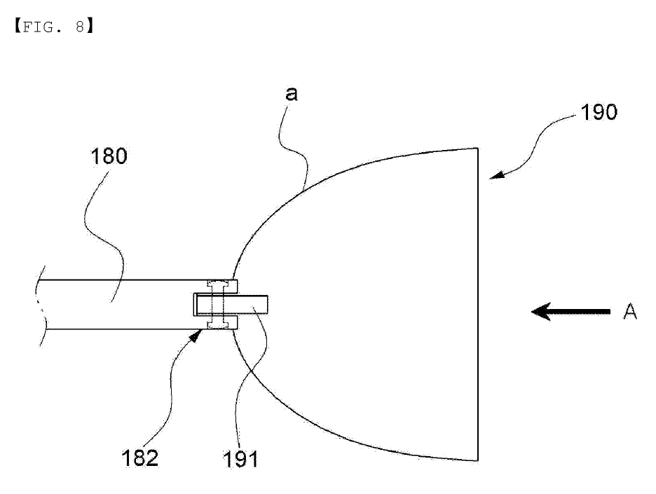

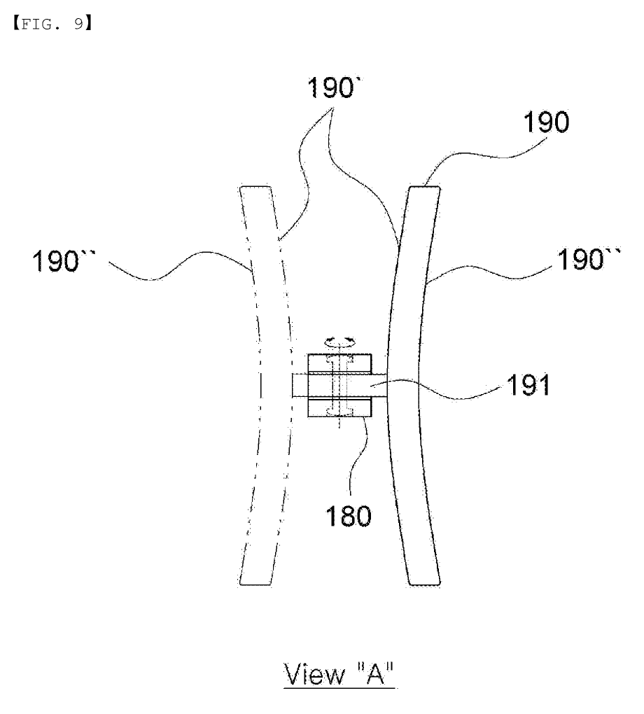

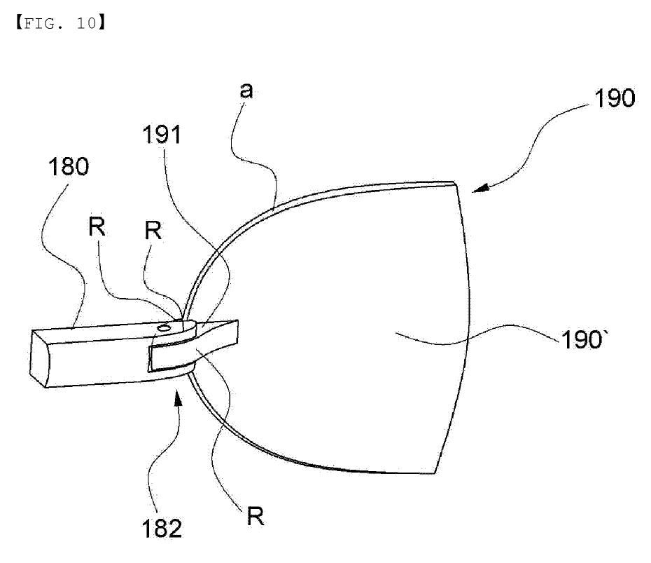

Further, with reference to FIGS. 8 to 10, FIG. 8 is a front view illustrating the resistance plate according to another embodiment of the present invention, FIG. 9 illustrates a shape as viewed in direction “A” in FIG. 8, and FIG. 10 is a perspective view illustrating the resistance plate shown in FIG. 8

As shown in FIG. 8 and later, the resistance plate 190 is formed of a curve (a) which increases in width with increasing distance from the hinge.

That is, the surface of the resistance plate 190 has upper and lower ends to form a curve (a) such that a width of upper and lower parts becomes wider toward one side of the resistance plate 190.

Further, the support part 182 is rotatably hinge-coupled by arranging the hinge in the center of the resistance plate so that the resistance plate 190 is rotatably coupled.

In this case, a hinge-coupled part 191 of the resistance plate 190 is inserted into the rotary support 180 to attain hinge-coupling, and a hinge pin is fully inserted into a coupling hole of the rotary support 180 to thus form no protrusion.

Further, the hinge-coupled part 191 of the resistance plate 190 as well as one end of the support part 182 are rounded (R) in a curved form.

Therefore, since the upper and lower portions of the resistance plate 190 form a curve (a), the support part 182 does not have any protrusion, and the hinge-coupled part 191 of the resistance plate 190 as well as the rotary support 180 are rounded (R), a net or other suspended matters flowing in the fluid are not caught (or stuck) in the support part 182 or the resistance plate 190, thereby attaining electricity generation by smooth movement of the fluid.

On the other hand, as shown in FIG. 9, when the resistance plate 190 rotates and is superimposed on the rotary support 180, the upper and lower portions of the resistance plate 190 are formed in a bent shape toward the center of the resistance plate so that a rear surface 190′ of the resistance plate in contact with the rotary support 180 is formed to be convex while a front surface 190″ opposite to the rear surface 190′ becomes concave.

That is, when the resistance plate 190 is arranged to be superimposed on the rotary support 180, the front surface 190″ is concave to improve resistance of the resistance plate 190.

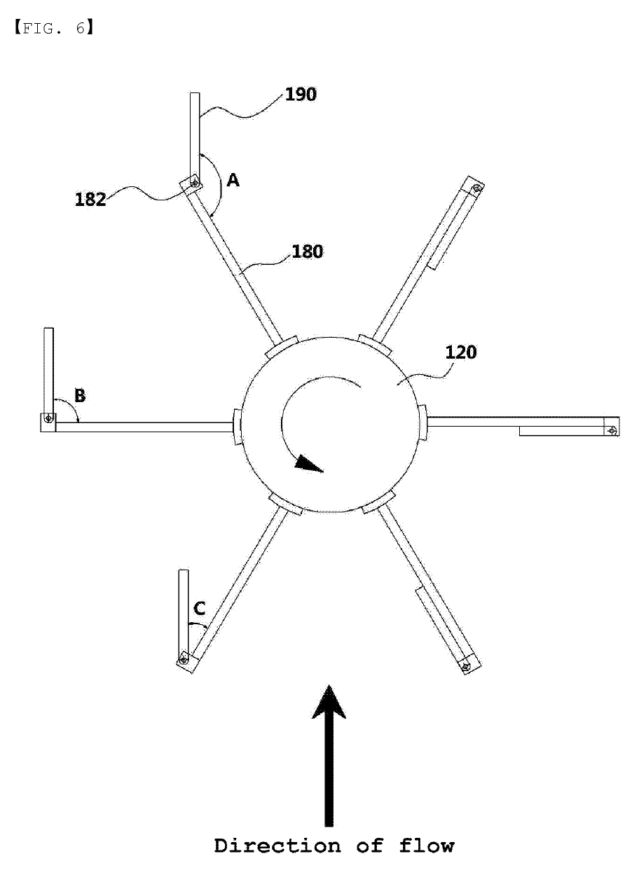

Hereinafter, an arrangement of the resistance plate capable of generating a rotating force in order to achieve rotation in the same direction regardless of the direction of flow will be described with reference to FIG. 6.

FIG. 6 illustrates an arrangement structure that maximizes the rotating force because a resistance force of the resistance plate is maximized at the right side when the flow rate is directed from the bottom to the top.

That is, as shown in FIG. 6, the resistance plate includes: a plurality of rotary supports 180 formed in radial direction with respect to the rotator; and a resistance plate 190 rotatably coupled to one side of the rotary support, which is opposed to the rotator, by a hinge, wherein the rotary support includes a support part 182 to which the resistance plate is rotatably coupled and by which the resistance plate is supported.

Referring to FIG. 6, it could be seen that the resistance plate 190 receives a force of the fluid and generates a rotating force (a resistance force of the resistance plate) to rotate the rotator, wherein an angle for maximum rotating force (see the right side in FIG. 6) is different from an input direction of the flow by 90 degrees.

In addition, it could be seen that an angle for minimum rotating force (see the right side in FIG. 6) is different from the angle for maximum rotating force by 180 degrees. In this case, it is identified that the resistance plate 190 is arranged in a direction perpendicular to the direction of flow at the angle for maximum rotating force, whereas the resistance plate is arranged parallel to the direction of flow at the angle for minimum rotating force.

Again, referring to FIG. 6, the resistance plate 190 is rotatably coupled to one side of the rotary support 180 by a hinge to thus rotate according to a flow rate of fluid, wherein the rotating resistance plate 190 is arranged to be superimposed on the rotary support 180 at an angle for maximum rotating force (see the right side in FIG. 6) so that the rotary support is arranged parallel to the resistance plate, whereas the rotating resistance plate 190 is arranged to be spaced apart from the rotary support 180 by 90 degrees at an angle for minimum rotating force (see the left side in FIG. 6) so that the rotary support is disposed at a right angle (see angle B) to the resistance plate.

Therefore, the rotator 120 rotates by the resistance plate with the maximum rotating force generated as shown in FIG. 6. Further, an angle between the resistance plate and the rotary support may be varied while rotating the rotary support and the resistance plate together by rotation of the rotator. Briefly, the angle between the rotary support and the resistance plate is 0 degrees at a point at which the rotating force becomes maximum (see the left side in FIG. 6) while the angle between the rotary support and the resistance plate is 90 degrees at another point at which the rotating force becomes minimum, wherein this angle is varied in the range of 0 to 90 degrees.

In addition, when viewing the rotator 120 in the direction of flow as shown in FIG. 6, if the resistance plate and the rotary support are arranged to achieve the maximum rotating force at the right side, the rotator rotates in the counterclockwise direction. Conversely, if the resistance plate and the rotary support are arranged to achieve the maximum rotating force at the left side, the rotator rotates in the clockwise direction. In this regard, with respect to a difference in such arrangement, when viewed in the direction of flow as shown in FIG. 6, if the resistance plate is disposed at the front before the rotary support at the right side, the rotator rotates in the counterclockwise direction. On the contrary, if the resistant plate is disposed at the rear after the rotary support, the rotator rotates in the clockwise direction.

Therefore, even when the flow direction of fluid is changed to any direction, a rotational direction of the rotator is not altered because of arrangement of the resistance plate and the rotary support.

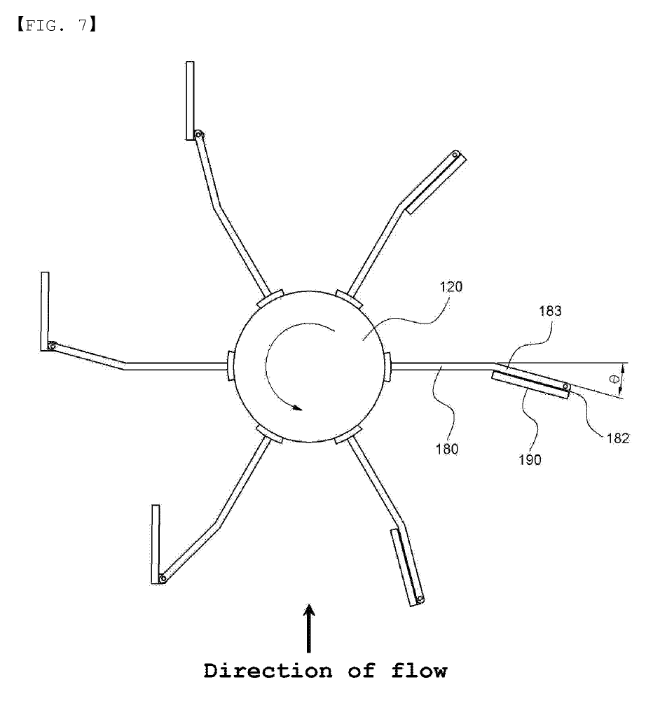

Moreover, FIG. 7 illustrates the behavior of a rotator according to another embodiment in the rotary support of the present invention.

As shown in FIG. 7, the rotary support 180 has a bent part 183 bent by a predetermined angle (θ) in a direction opposite to the rotational direction of the rotator 120 when the rotator rotates in the same direction.

That is, referring to FIG. 7, the rotator 120 rotates to the left side as the counterclockwise direction, while the bent part 183 of the rotary support 180 is bent in the direction opposite to the rotational direction of the rotator 120.

Accordingly, it is possible to prevent the resistance plate 190 from rotating by centrifugal force of the rotary support 180. In other words, even though the resistance plate 190 may rotate due to the centrifugal force caused by rotation of the rotator 120 in a condition wherein the resistance plate 190 is superimposed on the rotary support 180, such rotation may be prevented by the bent part 183 formed as described above.

One having ordinary skill in the art will appreciate that the present invention may be embodied in other specific forms without changing the technical spirit and/or essential features of the invention. Therefore, the embodiments described above should be understood as illustrative and non-restrictive examples only. The scope of the present invention is represented by the appended claims rather than the foregoing description, and all modifications and/or alternations derived from the meanings, ranges and equivalent concepts of the claims are duly construed to be within the scope of the present invention.

1. A hydropower generator for generating electricity while rotating in a flow direction of fluid, comprising:
a central structure installed to stand upright in water;
a rotator installed on an outer circumference of the central structure and having at least one resistance plate coupled to the outer circumference;
a rotational ring provided between the central structure and the rotator to allow the rotator to rotate around the central structure;
a speed changing unit (‘transmission’) which is coupled to the rotator at one side of the transmission and integrally rotates along with the rotator; and
a generator having a motor shaft coupled to another side of the transmission to generate energy by rotation of the motor shaft,
wherein the resistance plate is disposed in the water and generates a resistance force along water flow while simultaneously rotating the rotator, thereby generating energy from the generator, and
wherein the resistance plate is configured to be arranged to generate a rotating force such that the rotator can rotate in the same direction regardless of a direction of flow.

2. The hydropower generator according to claim 1, wherein the resistance plate includes:
a plurality of rotary supports formed in a radial direction with respect to the rotator; and
a resistance plate rotatably coupled to one side of the rotary support, which is opposed to the rotator,
wherein the rotary support further includes a support part to which the resistance plate is rotatably coupled and by which the resistance plate is supported,
wherein a portion of the rotary support stops rotation of the resistance plate to generate a resistance force, and the resistance plate generates the resistance force while rotating at one side of the rotary support toward a center of the rotator, and
wherein the resistance force is generated when the resistance plate is arranged to be superimposed on the rotary support, thereby rotating the rotator.

3. The hydropower generator according to claim 2, wherein the resistance plate is rotatably hinge-coupled to one side of the rotary support by the hinge, to thus rotate depending upon a direction of flow,
wherein the resistance plate is arranged to be superimposed on the rotary support at a position at which the rotating force is generated, so that the resistance plate is arranged parallel to the rotary support, while the resistance plate is arranged parallel to the direction of flow at another position at which the rotating force is not generated, so that the rotator can rotate due to a deviation in rotating force generated in the resistance plate.

4. The hydropower generator according to claim 3, wherein,
when viewing the rotator in the direction of flow, if the resistance plate and the rotary support are arranged such that rotation of the resistance plate is stopped by the rotator support to thus generate the resistance force at a right side with respect to the rotator, the rotator rotates in a counterclockwise direction, whereas, if the resistance plate and the rotary support are arranged such that rotation of the resistance plate is stopped by the rotary support to thus generate the resistance force at the left side with respect to the rotator, the rotator rotates in a clockwise direction.

5. The hydropower generator according to claim 2, further comprising a base member for supporting the rotator and the central structure, wherein the rotator has a hollow cylindrical shape and receives a portion of the central structure therein, and
wherein a cover part having a thru-hole through which the central structure passes is formed on top of the rotator, and wherein the central structure has a stepped part projecting in a radial direction from the outer circumference of the central structure such that a central structure is spaced apart from a bottom of the cover part of the rotator.

6. The hydropower generator according to claim 5, wherein a rotational ring provided between the rotator and the central structure includes a plurality of internal rolling rings with a multilayer structure present between an inner circumference of the rotator and an outer circumference of the central structure, wherein the internal rolling rings are provided to support the rotator, thereby enabling the rotator to rotate around a center axis of the central structure.

7. The hydropower generator according to claim 6, wherein the rotational ring further includes:
an upper rolling ring provided between the cover part of the rotator and the stepped part of the central structure to support an upper portion of the rotator;
a lower rolling ring provided between the base member and a bottom of the rotator to support a lower portion of the rotator,
wherein both of the upper rolling ring and the lower rolling ring are provided together or either one thereof is selectively provided.

8. The hydropower generator according to claim 1, wherein the rotator is provided with a gear member on an upper portion of the outer circumference of the rotator, and
the transmission includes: a power connection gear coupled to the above gear member in the rotator; a gear shift coupled to a motor shaft of the power generator; and a power transmission shaft which connects the power connection gear and the gear shift to transmit the rotating force, wherein a rotational speed of the rotator is variable depending upon the number of teeth of both the power connection gear and the gear shift.

9. The hydropower generator according to claim 2, wherein a portion of the rotary support stops rotation of the resistance plate to allow generation of a resistance force, wherein an exposed face of the rotary support in the direction of flow, which comes in contact with the resistance plate, is formed in a planar or concave shape in order to increase the resistance force, thereby stopping the resistance plate.

10. The hydropower generator according to claim 2, wherein a hinge rotatably coupled to the resistance plate has a configuration wherein a hinge is disposed in a center of one end of the resistance plate or is mounted on a bracket extending up and down from an end of the rotary support to support top and bottom faces of the resistance plate.

11. The hydropower generator according to claim 10, wherein the resistance plate is formed in a curved line having an increased width with increasing distance from the hinge, so as to prevent foreign substances from sticking to the resistance plate.

12. The hydropower generator according to claim 2, wherein the rotary support and the resistance plate are formed with at least one multilayer structure, wherein the rotary support and the resistance plate are divided and mounted at equal angles to total 360 degrees on each layer.

13. The hydropower generator according to claim 2, wherein, when the resistance plate rotates and is superimposed on the rotary support, a upper and lower portions of the resistance plate are formed in a bent shape toward a center of the resistance plate so that a rear surface of the resistance plate in contact with the rotary support is formed to be convex while a front surface opposite to the rear surface becomes concave.

14. The hydropower generator according to claim 2, wherein the rotary support has a bent part bent by a predetermined angle (θ) in a direction opposite to the rotational direction of the rotator when the rotator rotates in the same direction, thereby preventing the resistance plate from rotating by a centrifugal force of the rotary support.
